(19) United States
(12) Patent Application Publication
(10) Pub. No.: US 2025/0329041 A1
(43) Pub. Date: Oct. 23, 2025

(54) METHOD AND SYSTEM FOR NAIL RECOGNITION AND POSITIONING

(71) Applicant: SHANGHAI MEINAIER TECHNOLOGY CO., LTD., Shanghai (CN)

(72) Inventors: Yong XIANG, Shanghai (CN); Jin YAN, Shanghai (CN)

(21) Appl. No.: 19/253,877

(22) Filed: Jun. 29, 2025

Related U.S. Application Data
(63) Continuation of application No. PCT/CN2023/138260, filed on Dec. 12, 2023.

(30) Foreign Application Priority Data
Dec. 29, 2022 (CN) 202211707970.6

(51) Int. Cl. G06T 7/70; A45D 31/00; G06T 5/70; G06T 7/11

(52) U.S. Cl. CPC G06T 7/70; A45D 31/00; G06T 5/70; G06T 7/11; G06T 2207/10028; G06T 2207/20024; G06T 2207/30196

(57) ABSTRACT

A method and system for nail recognition and positioning are disclosed. The method includes: S1, acquiring, by a recognition device, first image information of an operating area through photographing, sending the first image information to a target-detecting network to generate corresponding second image information, and comparing to obtain nail mask images after performing segmentation; S2, obtaining true coordinates of a nail point cloud through calculation of an original 3D point cloud and the nail mask images; S3, converting the nail point cloud to a calibration coordinate system, which is determined by locating a printing device below the identification device; S4, traversing each nail to obtain angle information of the nails according to point cloud information of the nails; and S5, projecting point cloud coordinates of each nail to a two-dimensional plane, and obtaining a deflection angle of each nail.

### CROSS-REFERENCE TO RELATED APPLICATIONS

The present application is a U.S. Continuation of International Application PCT/CN2023/138260 filed on Dec. 12, 2023, which claims the benefit of and priority to Chinese patent application No. 202211707970.6 filed with China National Intellectual Property Administration on Dec. 29, 2022, the content of the aforementioned applications is incorporated herein by reference in their entireties.

### TECHNICAL FIELD

The present invention relates to the field of intelligent nail decorating, and more specifically, to a method and system for nail recognition and positioning.

### BACKGROUND

Currently, most intelligent nail decorating machines only perform printing on a single nail surface. Before preparing for nail decorating, the nail decorating machine first needs to pre-coat the nail surface with nail gel, where the color of the nail gel is different from the surrounding environment of the handrest and the color of the finger, and then recognize the contour of the nail, which severely restricts the nail decorating time and recognition accuracy. Moreover, since only a single nail is printed, there is no need to recognize the deflection angle and tilt situation of the nail surface.

### SUMMARY

The object of the present invention is to provide improved method and system for nail recognition and positioning.

In order to achieve the above object, the present invention adopts the following technical solution, a method for nail recognition and positioning includes:
step S1: acquiring, by a recognition device, first image information of an operating area through photographing, positioning locations of nails in the first image information through a target-detecting network to generate corresponding second image information, transmitting the second image information to a segmentation network to divide the second image information into a plurality of regions, and comparing the first image information with the divided second image information after pre-setting a probability value, to obtain nail mask images of the first image information;
step S2: obtaining true coordinates of a nail point cloud through calculation of an original 3D point cloud and the nail mask images, and performing statistical filtering on the nail point cloud to eliminate noise points of the point cloud;
step S3: converting the nail point cloud to a calibration coordinate system, which is determined by locating a printing device below the recognition device;
step S4: traversing each nail to obtain information including a highest point, left/right tilt angles, and front/back tilt angles of the nails according to point cloud information of the nails;
step S5: projecting point cloud coordinates of the nails to a two-dimensional plane, performing Gaussian filtering to eliminate potential noise points, and obtaining a deflection angle of each nail according to a two-dimensional image.

Preferably, the step S5 further includes:
step S51: calculating a length-width ratio α of a contour of a nail based on the two-dimensional image;
step S52: obtaining a deflection angle B of a finger contour from third image information when α>a first threshold value, and calculating an absolute value A−B of a difference between the deflection angle B and a rotation angle A of a minimum rectangle enclosing the contour of the nail;
step S53: regarding the deflection angle B as a final deflection angle when |A−B|>a second threshold value, and retaining, otherwise, the rotation angle A as the final deflection angle.

Optionally, the step S1 further includes:
step S11: acquiring, by the recognition device, a photo of positions of fingers in the operating area to obtain the first image information, and sending the first image information to the target-detecting network to perform positioning for nail sections in the first image information so as to generate the corresponding second image information, which mainly includes image information of the nail sections;
step S12: sending the second image information to the segmentation network, pre-setting a probability value of judgment, obtaining a probability value that each pixel in an original hand image belongs to a nail section, marking pixel points with a probability value greater than the preset probability value as the nail section, marking pixel points with a probability value less than the preset probability value as a non-nail section, so as to obtain the nail mask images of the first image information.

Optionally, the step S2 further includes:
step S21: calculating the nail mask images and original 3D point cloud data to obtain true point cloud coordinates of the nails, where the original 3D point cloud data are data set in a real world;
step S22: performing filtering on each nail mask image to eliminate noise points of the point cloud, such that an accuracy of image information is fed back through the point cloud.

Optionally, the step S3 further includes:
step S31: setting, based on the recognition device, an initial position of the printing device below the recognition device as the calibration coordinate system;
step S32: sending a true point cloud of the nails to the calibration coordinate system, where the true point cloud is obtained by combining the nail mask images with the original 3D point cloud;
Optionally, the step S4 further includes:
step S41: traversing, according to a point cloud of each nail, the nails, and obtaining basic data of the nails by combining point cloud data;
step S42: performing, after traversing the nails according to the point cloud data, data sorting for the point cloud of the nails to obtain the highest point, the left/right tilt angle and the front/back tilt angle of the nail point cloud.

Optionally, the step S5 further includes:
step S51: projecting point cloud coordinates of the nails to the two-dimensional plane according to external parameters of the camera, performing Gaussian filtering to eliminate potential noise points, and obtaining the deflection angle of each nail according to the two-dimensional image.

Specifically, the nail mask image of each nail can be individually extracted in advance, an image contour of each nail mask is extracted through an image processing function library, and minimum rectangle fitting is performed. After the fitting is completed, the minimum rectangle is translated so that the upper left vertex of the minimum rectangle is regarded as the origin, and the angle formed by the side of the minimum rectangle in the length direction of the finger and the x-axis is the deflection angle of the nail.

Optionally, the segmentation network includes but is not limited to Unet, pspnet, deeplab series, etc. for performing segmentation and comparison on the second image information.

Optionally, the recognition device is one of a 3D camera, an RGB binocular camera, a 2D/3D laser radar, a 3D structured light camera, or a tof camera.

A system for nail recognition and positioning, applicable for the method in any one of the above technical solutions, including:
an image processing module, configured to receive the first image information sent by the recognition device and generate the second image information according to nail sections corresponding to the first image information.
a communication module, configured to send the second image information to the segmentation network through the communication module to perform segmentation on an image of nail sections therein, and return divided nail mask images to the image processing module.
a control module, configured to preset a probability value, to compare the divided second image information with the first image information, to determine a probability value that a corresponding pixel belongs to a nail section, to mark pixel points with a probability value greater than the preset probability value as the nail section, and to mark pixel points with a probability value less than the preset probability value as the non-nail section, so as to obtain the nail mask images of the first image information.
a 3D point cloud calculation module, configured to combine the nail mask images with the original 3D point cloud to obtain true point cloud coordinates of the nails, and convert the nail point cloud to the calibration coordinate system, so that the printing device performs printing according to a location of the calibration coordinate system.
an information processing module, configured to collect and process calculated or converted 3D point cloud coordinates and to obtain the tilt angles according to the 3D point cloud coordinates.

Optionally, the calibration coordinate system represents an x-y plane, parallel to a plane of the printing device.

The above technical solution has the following advantages or beneficial effects:
1. By segmenting the image information of the nail and comparing it with the first image information, a nail mask image is obtained, and the nail mask image is operated with the original 3D point cloud to obtain the true point cloud coordinates of each nail, so that the shape of the nail can be reflected by a plurality of point cloud coordinates.
2. After obtaining the true point cloud of the nail, the point cloud is converted to the calibration coordinate system, so that the point cloud coordinates are converted into the coordinate system applicable for the printing device, which can reduce errors in the printing process and make the printed pattern more accurate.
3. The position of the nail can be calibrated through the nail point cloud, and the tilt angles of the nail can be calculated through the point cloud of up/down end points or left/right end points, so that the nail can be adjusted before printing.

### BRIEF DESCRIPTION OF THE DRAWINGS

FIG. 1 is a flow chart of a method for nail recognition and positioning provided by the present invention.

FIG. 2 is a flow chart of a method for nail recognition and positioning provided by the present invention.

FIG. 3 is a flow chart of a method for nail recognition and positioning provided by the present invention.

FIG. 4 is a flow chart of a method for nail recognition and positioning provided by the present invention.

FIG. 5 is a flow chart of a method for nail recognition and positioning provided by the present invention.

FIG. 6 is a flow chart of a method for nail recognition and positioning provided by the present invention.

FIG. 7 is a schematic structural diagram of a system for nail recognition and positioning provided by the present invention.

### REFERENCE NUMERAL

1. Image processing module; 2. Communication module; 3. Control module; 4. 3D point cloud calculation module; 5. Information processing module.

### DETAILED DESCRIPTION

The technical solutions in the embodiments of the present invention will be clearly and completely described below in conjunction with the accompanying drawings in the embodiments of the present invention. Obviously, the described embodiments are only a part of the embodiments of the present invention, rather than all the embodiments. All other embodiments obtained by those of ordinary skill in the art based on the embodiments of the present invention without creative efforts shall fall within the protection scope of the present invention.

As used herein, the term deflection angle refers to a counterclockwise rotation angle (2D) of the minimum rectangle enclosing the contour of the nail relative to the horizontal X-axis.

As used herein, the term tilt angle is the tilt angle (3D) of the surface of the nail relative to the horizontal plane.

Currently, most intelligent nail decorating machines only perform printing on a single nail surface. Before preparing for nail decorating, the nail decorating machine first needs to pre-coat the nail surface with nail gel, where the color of the nail gel is different from the surrounding environment of the handrest and the color of the finger, and then recognize the contour of the nail, which severely restricts the nail decorating time and recognition accuracy. Moreover, since only a single nail is printed, there is no need to recognize the deflection angle and tilt situation of the nail surface.

At present, a solution is adopted where the four fingers (the four fingers refer to the index finger, middle finger, ring finger, and little finger) and the thumb are arranged on different planes, that is, according to the structure of the human hand, the left thumb is arranged on the right side of the handboard, perpendicular to the plane where the four fingers are located, and the right thumb is arranged on the left side of the handboard, perpendicular to the plane where the four fingers are located. In this solution, after the fingers are placed in the operating area, the nail surface will rotate and tilt. In addition, the existing technology recognizes a single nail, and the nail surface needs to be pre-coated with nail gel, the color of which is different from the surrounding environment of the handrest and the color of the finger, usually white, and then recognition is performed. The steps are cumbersome, increasing the nail decorating time.

It should be noted that the applicant has previously applied for a patent with the publication number CN113469093A, which is a nail recognition method and system based on deep learning. By pre-acquiring the original hand image, obtaining the probability value of each pixel in the original hand image belonging to the nail section, and obtaining the nail mask image of the original hand image, extracting the contour coordinates of the nail in the nail mask image and obtaining the deflection angle and tilt information of each nail, it is realized that there is no need to pre-coat the nail surface with nail gel and anti-overflow gel before nail recognition, and multiple nails can be recognized at the same time, with higher recognition accuracy and less overall time required, which can solve the problems in the above technologies. However, the obtained nail mask image is a two-dimensional image, and the position and area of the nail are reflected by the two-dimensional mask image. The problem with this patent is that the nail is an arc surface, each finger is not with the nail surface facing upward, and there is a certain tilt angle. The rotation information is included in the depth (Z-axis), and the two-dimensional image cannot process it. At the same time, the height of each finger nail is completely different, and the two-dimensional information has no Z-axis data and cannot judge the height. The lack of Z-axis data will cause serious errors in the spraying process, affecting the nail decorating effect. As mentioned above, the slope of the nail on the X and Y axes is called the rotation angle; the slope of the nail on the Z axis is called the tilt angle.

Therefore, the purpose of the present invention is to provide an improved method and system for nail recognition and positioning in order to solve the problem that there is an error caused by an tilt angle and a height difference in the existing nail decorating machine in the process of nail recognition and spraying.

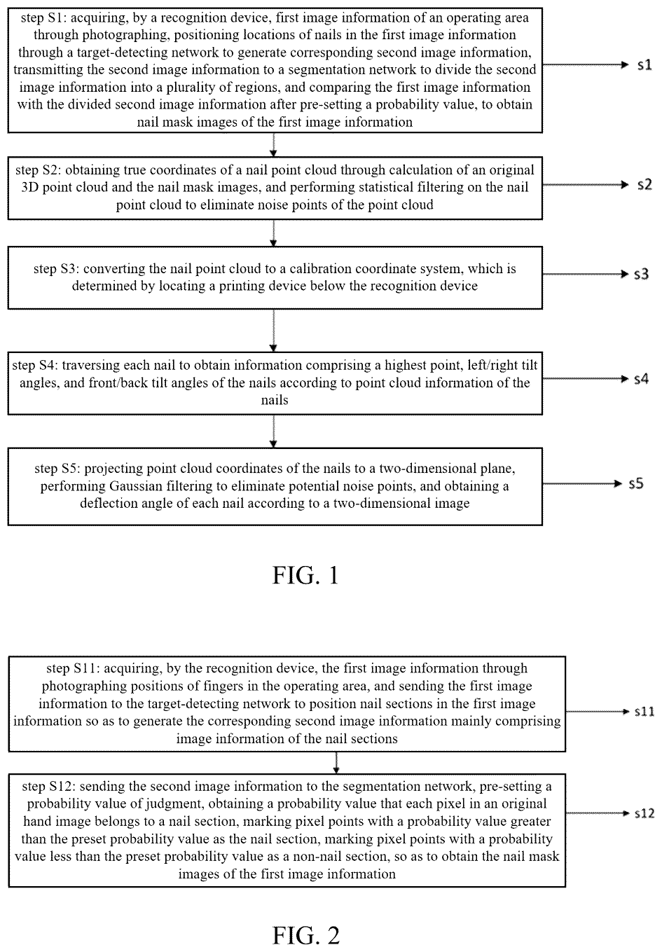

With reference to FIG. 1, an embodiment provided by the present invention: A method for nail recognition and positioning includes:
step S1: acquiring, by a recognition device, first image information of an operating area through photographing, positioning locations of nails in the first image information through a target-detecting network to generate corresponding second image information, transmitting the second image information to a segmentation network to divide the second image information into a plurality of regions, and comparing the first image information with the divided second image information after pre-setting a probability value, to obtain nail mask images of the first image information;
step S2: obtaining true coordinates of a nail point cloud through calculation of an original 3D point cloud and the nail mask images, and performing statistical filtering on the nail point cloud to eliminate noise points of the point cloud;
step S3: converting the nail point cloud to a calibration coordinate system, which is determined by locating a printing device below the recognition device;
step S4: traversing each nail to obtain information including a highest point, left/right tilt angles, and front/back tilt angles of the nails according to point cloud information of the nails;
step S5: projecting point cloud coordinates of the nails to a two-dimensional plane, performing Gaussian filtering to eliminate potential noise points, and obtaining a deflection angle of each nail according to a two-dimensional image.

In this embodiment, the recognition device acquires a photo to recognize the fingers placed in the operating area, generates first image information, which is the original image of the fingers, positions the nails in the generated first image information, generates second image information based on an image of nail sections, and sends it to the segmentation network. After dividing the second image information into several regions, it is compared with the first image information to obtain a nail mask image. The nail mask image is operated with the original 3D point cloud data to obtain the true point cloud coordinates of the nails, and the noise is eliminated. The point cloud is converted to the calibration coordinate system to determine the position of the coordinate system. Each nail is traversed, each point cloud coordinate is collected to obtain point cloud coordinate information, and then the highest point of the nail, the left/right tilt angle, the front/back tilt angle and other information are judged. The point cloud coordinates of the nail are projected onto a two-dimensional plane according to external parameters of the camera, and the corresponding reference system coordinates are calculated through the external parameters. Gaussian filtering is performed to eliminate possible noise points, so that the reference system position is more accurate.

As used herein, the term external parameter refers to a matrix of converting relationships from the object world coordinate system to the camera coordinate system. The acquisition method of the external parameters includes calculating the external parameter matrix of the camera by calibration. Specifically, the nail point cloud can be converted from the camera coordinate system to the calibration coordinate system according to the external parameters, and then projected along the Z-axis to obtain a nail pattern. The pattern is subjected to Gaussian filtering, median filtering, and first-closing-then-opening morphology operations to obtain the nail contour to be printed.

The point cloud can automatically measure the information of a large number of points on the surface of an object and then output the point cloud data in a data file. These point cloud data are collected by the scanning device, and the point cloud can also be created by using the scanned image and the internal parameters of the scanning camera. The method is to calculate the real-world points (x, y, z) through camera calibration and the internal parameters of the camera. The relationship between the 3D points in the world coordinate system and the points (u, v) in the image needs to be assisted by the camera coordinate system and the image coordinate system. The converting from the world coordinate system to the camera coordinate system (external parameters) is as follows:

$$P = {RP}_{w} + t \\ [ \begin{matrix}{X}_{c} \\ {Y}_{c} \\ {Z}_{c}\end{matrix} ] = R \cdot [ \begin{matrix}{X}_{w} \\ {Y}_{w} \\ {Z}_{w}\end{matrix} ] + t$$

The corresponding 3D points can be obtained, where [R|T] is the external parameter of the camera.

From the camera coordinate system to the points in the image (internal parameters), this process is to map the three-dimensional point PC=[XC, YC, ZC]<τ> in the camera coordinate system to the two-dimensional point p=(x, y) in the image plane coordinate system through matrix converting. The relationship between the three-dimensional coordinate points and the two-dimensional coordinate points in the image coordinate system is mapped to facilitate more accurate calculation of the position.

As used herein, the term internal parameter includes focal length, principal point coordinates, and distortion coefficients, enabling objects in the real world to be mapped from the camera coordinate system to the pixel coordinate system.

With reference to FIG. 2, the step S1 further includes:
step S11: acquiring, by the recognition device, a photo of positions of fingers in the operating area to obtain the first image information, and sending the first image information to the target-detecting network to perform positioning for nail sections in the first image information so as to generate the corresponding second image information, which mainly includes image information of the nail sections;
step S12: sending the second image information to the segmentation network, pre-setting a probability value of judgment, obtaining a probability value that each pixel in an original hand image belongs to a nail section, marking pixel points with a probability value greater than the preset probability value as the nail section, marking pixel points with a probability value less than the preset probability value as a non-nail section, so as to obtain the nail mask images of the first image information.

In this embodiment, the recognition device can be a 3D camera, and the segmentation network includes but is not limited to Unet, pspnet, deeplab series, etc., to perform segmentation and comparison on the second image information to obtain the probability value of each pixel in the original image belonging to the nail section, with a range of 0-1. The deep learning segmentation method avoids complex feature processing and has good detection accuracy and boundary accuracy. Assuming that the preset probability value is 0.5, when comparing, the pixel points greater than the preset probability value are marked as the nail section, and the pixel points less than the preset probability value are marked as the non-nail section. The areas marked by several pixel points are spliced to form a nail mask image. In some cases, multiple nail regions may be segmented, and splicing is required. However, there is only one nail region in most cases.

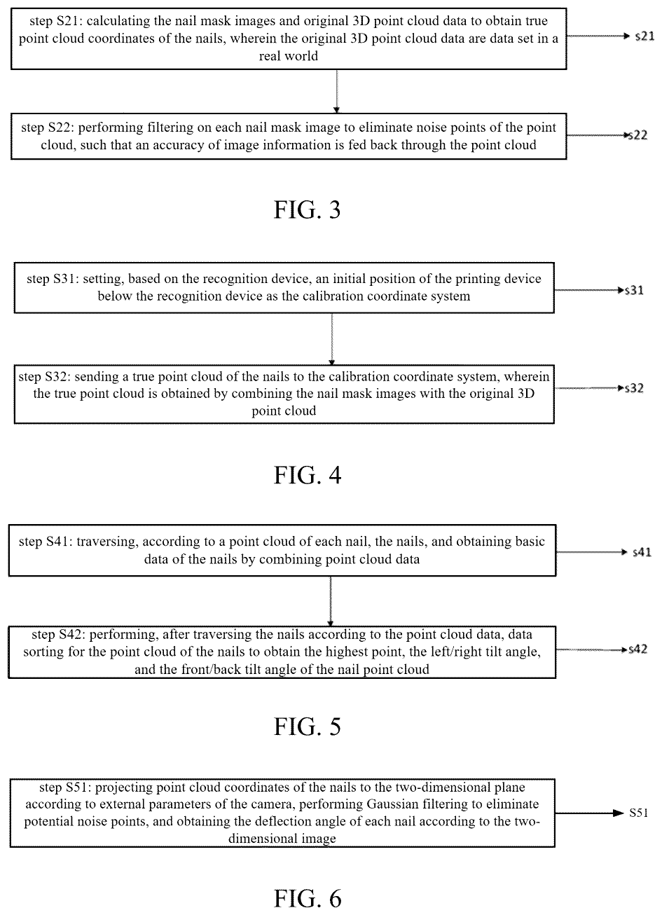

With reference to FIG. 3, the step S2 further includes:
step S21: calculating the nail mask images and original 3D point cloud data to obtain true point cloud coordinates of the nails, where the original 3D point cloud data are data set in a real world;
step S22: performing filtering on each nail mask image to eliminate noise points of the point cloud, such that an accuracy of image information is fed back through the point cloud.

In this embodiment, the nail mask image is operated with the 3D point cloud data to obtain the true point cloud coordinates of the nail, and the nail mask image can be subjected to median filtering to obtain a new nail mask image.

Specifically, the calculation in calculating the nail mask image and the original 3D point cloud data refers to determining a region of the nail point cloud by a one-to-one correspondence relationship between pixel points of the nail mask image and the point cloud. Then, the nail point cloud is projected along the Z-axis to obtain a nail pattern. After performing Gaussian filtering and median filtering on the pattern to remove noise points, a new nail mask image is obtained.

With reference to FIG. 4, the step S3 further includes:
step S31: setting, based on the recognition device, an initial position of the printing device below the recognition device as the calibration coordinate system;
step S32: sending a true point cloud of the nails to the calibration coordinate system, where the true point cloud is obtained by combining the nail mask images with the original 3D point cloud. In an example, the point cloud of the nail in the camera coordinate system may be multiplied by external parameters of the camera to obtain the point cloud of the nail in the calibration coordinate system.

In this embodiment, the printing device is an inkjet head, and the calibration coordinate system represents an x-y plane parallel to the plane of the printer. The relative position of the printing device below is determined by the position of the recognition device, and the initial position of the printing device is set as the calibration coordinate system.

With reference to FIG. 5, the step S4 further includes:
step S41: traversing, according to a point cloud of each nail, the nails, and obtaining basic data of the nails by combining point cloud data;
step S42: performing, after traversing the nails according to the point cloud data, data sorting for the point cloud of the nails to obtain the highest point, the left/right tilt angle and the front/back tilt angle of the nail point cloud.

Specifically, the nail mask image of each nail can be individually extracted in advance, the image contour of each nail mask is extracted by an image processing function library, and the minimum rectangle of the contour of the nail can be obtained by minimum rectangle fitting, left/right and up/down end points of the nail are obtained according to an intersection of the rectangle and the contour of the nail, a left/right tilt angle of the nail is calculated according to point cloud coordinates of the left/right end points, and an forward-backward tilt angle is calculated according to point cloud coordinates of the up/down end points.

In this embodiment, by traversing the point cloud coordinates of the nails, collecting them through three algorithms of pre-order, in-order, or post-order, taking the identified several coordinates as a set, and analyzing the data in the set, the highest point of the nail point cloud and the lowest points around it can be obtained, and the left/right tilt angle and front/back tilt angle can be calculated through the corresponding coordinate system, which has high accuracy.

With reference to FIG. 6, the step S5 further includes:
step S51: projecting point cloud coordinates of the nails to the two-dimensional plane according to external parameters of the camera, performing Gaussian filtering to eliminate potential noise points, and obtaining the deflection angle of each nail according to the two-dimensional image.

In an example, the projecting point cloud coordinates of the nails to the two-dimensional plane according to external parameters of the camera may include: converting the point cloud of the nails into a calibration coordinate system according to external parameters of the camera and projecting it to the two-dimensional plane along the Z-axis.

Specifically, the nail mask image of each nail can be individually extracted in advance, an image contour of each nail mask is extracted through an image processing function library, and minimum rectangle fitting is performed. After the fitting is completed, the minimum rectangle is translated so that the upper left vertex of the minimum rectangle is regarded as the origin, and the angle formed by the side of the minimum rectangle in the length direction of the finger and the x-axis is the deflection angle of the nail.

In this embodiment, after obtaining the deflection angle of each nail, the nail mask image of each nail is individually extracted, and the length and width of the external rectangle of the contour of the nail are enlarged to an appropriate multiple (in this embodiment, it can be enlarged by 2 times) as the length and width of the extracted image, which is convenient for subsequent contour extraction. The contour of each nail image can be extracted by using the Opencv image processing function library, such as findcounter, and the minimum rectangle fitting is used to return the deflection angle of the minimum rectangle relative to the X-axis as the deflection angle of the nail. The tilt direction and angle of the nail are judged according to the intersection of the rectangle and the contour of the nail.

In the above embodiments, the deflection angle of the printed pattern is calculated from the minimum rectangle enclosing the contour of the nail to be printed, and the rotation angle of the minimum rectangle enclosing the contour of the nail directly reflects the deflection angle of the pattern to be printed. However, in the aspect of the calculating logic of the deflection angle of the printed pattern, there is a problem that calculating the rotation angle for short nail and irregular nail contours by using the minimum rectangle enclosing the contour of the nail may be wrong and cause the pattern to be crooked. Therefore, the technical idea of introducing a USB camera is adopted to divide the finger area in USB image, so that the direction of the finger contour is taken as the deflection direction of printed pattern on the nail. The specific calculation process is as follows: firstly calculating the rotation angle A of the minimum rectangle enclosing the nail contour, then obtaining the deflection angle B of the finger contour from the USB finger image, and simultaneously calculating the length-width ratio α of the nail. The deflection angle is A when the length-width ratio α is greater than a first threshold value, and whether the absolute value of the angle difference between A and B is greater than the second threshold value is further judged when the length-width ratio α is not greater than the first threshold value. The deflection angle is B when the absolute value of the angle difference between A and B is not greater than the second threshold value, and the deflection angle is still A when the absolute value of the angle difference between A and B is greater than the second threshold value. It should be noted that images captured by any other suitable image capturing device other than USB images captured by the USB camera may be acquired, which is not limited in this application.

By way of example and not limitation, the first threshold value may be 1.2. Of course, those skilled in the art can adopt any other suitable first threshold value according to actual requirements, which is not limited in this application.

By way of example and not limitation, the second threshold value may be 6°. Of course, those skilled in the art can adopt any other suitable second threshold value according to actual needs, which is not limited in this application.

According to the embodiments of the present invention, the step S5 may further include:
step S51: calculating a length-width ratio α of a contour of a nail based on the two-dimensional image;
step S52: obtaining a deflection angle B of a finger contour from third image information when α>a first threshold value, and calculating an absolute value A-B of a difference between the deflection angle B and a rotation angle A of a minimum rectangle enclosing the contour of the nail;
step S53: regarding the deflection angle B as a final deflection angle when A−B>a second threshold value, and retaining, otherwise, the rotation angle A as the final deflection angle.

It is understood that the third image information may be a USB image acquired by the USB camera. Of course, those skilled in the art may adopt image information acquired by any other suitable image acquisition device as the third image information according to actual requirements, which is not limited in this application.

Specifically, the recognition device is one of a 3D camera, an RGB binocular camera, a 2D/3D laser radar, a 3D structured light camera, or a tof camera.

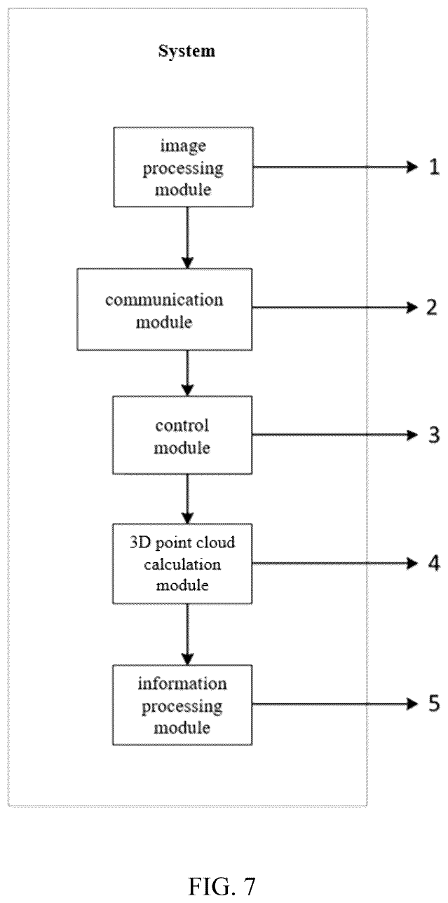

With reference to FIG. 7, an embodiment of a system for nail recognition and positioning is further included in the technical solution of the present invention. The system is applicable for the method in any one of the above technical solutions, and includes:
an image processing module 1, configured to receive the first image information sent by the recognition device and generate the second image information according to nail sections corresponding to the first image information;
a communication module 2, configured to send the second image information to the segmentation network through the communication module to perform segmentation on an image of nail sections therein, and return divided nail mask images to the image processing module;
a control module 3, configured to preset a probability value, compare the divided second image information with the first image information, to determine a probability value that a corresponding pixel belongs to a nail section, to mark pixel points with a probability value greater than the preset probability value as the nail section, and to mark pixel points with a probability value less than the preset probability value as the non-nail section so as to obtain the nail mask images of the first image information;
a 3D point cloud calculation module 4, configured to combine the nail mask images with the original 3D point cloud to obtain true point cloud coordinates of the nails, and convert the nail point cloud to the calibration coordinate system, so that the printing device performs printing according to a location of the calibration coordinate system;
an information processing module 5, configured to collect and process the calculated or converted 3D point cloud coordinates and to obtain the tilt angles according to the 3D point cloud coordinates.

Further, the calibration coordinate system represents an x-y plane, parallel to a plane of the printing device.

In this embodiment, the image processing module 1 receives the first image information sent by the recognition device, positions the nails in the generated first image information, generates second image information based on an image of nail sections, and sends the first image information to the target-detecting network and the second image information to the segmentation network through the communication module 2 to realize the transmission of image information. The control module 3 is configured to preset a probability value, to compare the divided second image information with the first image information, to mark the pixel points with a probability value greater than the preset probability value as the nail section, and to mark the pixel points with a probability value less than the preset probability value as the non-nail section, so as to obtain the nail mask image of the first image information. The 3D point cloud calculation module 4 can automatically measure the information of a large number of points on the surface of an object by using point clouds, and then output the point cloud data in a data file. The relationship between the three-dimensional coordinate points and the two-dimensional coordinate points in the image coordinate system is mapped, which is convenient for more accurate calculation of the position. The information processing module 5 collects and processes the calculated or converted 3D point cloud coordinates, obtains the tilt angles according to the 3D point cloud coordinates, traverses the point cloud coordinates of the nails, collects them through three algorithms of pre-order, in-order, or post-order, takes the identified several coordinates as a set, and analyzes the data in the set to obtain the highest point of the nail point cloud and the lowest points around it, and calculates the left/right tilt angle and front/back tilt angle through the corresponding coordinate system, which has high accuracy.

Finally, it should be noted that the above are only preferred embodiments of the present invention and are not intended to limit the present invention. Although the present invention has been described in detail with reference to the foregoing embodiments, for those skilled in the art, it is still possible to modify the technical solutions described in the foregoing embodiments, or perform equivalent replacements for some of the technical features. Any modification, equivalent replacement, improvement, etc. made within the spirit and principle of the present invention shall be included in the protection scope of the present invention.

What is claimed is:

1. A method for nail recognition and positioning, comprising:
step S1: acquiring, by a recognition device, first image information of an operating area through photographing, positioning locations of nails in the first image information through a target-detecting network to generate corresponding second image information, transmitting the second image information to a segmentation network to divide the second image information into a plurality of regions, and comparing the first image information with the divided second image information after pre-setting a probability value, to obtain nail mask images of the first image information;
step S2: obtaining true coordinates of a nail point cloud through calculation of an original 3D point cloud and the nail mask images, and performing statistical filtering on the nail point cloud to eliminate noise points of the point cloud;
step S3: converting the nail point cloud to a calibration coordinate system, which is determined by locating a printing device below the recognition device;
step S4: traversing each nail to obtain information comprising a highest point, left/right tilt angles, and front/back tilt angles of the nails according to point cloud information of the nails; and
step S5: projecting point cloud coordinates of the nails to a two-dimensional plane, performing Gaussian filtering to eliminate potential noise points, and obtaining a deflection angle of each nail according to a two-dimensional image.

2. The method for nail recognition and positioning according to claim 1, wherein the step S5 further comprises:
step S51: calculating a length-width ratio α of a contour of a nail based on the two-dimensional image;
step S52: obtaining a deflection angle B of a finger contour from third image information when α>a first threshold value, and calculating an absolute value A−B of a difference between the deflection angle B and a rotation angle A of a minimum rectangle enclosing the contour of the nail;
step S53: regarding the deflection angle B as a final deflection angle when A−B>a second threshold value, and retaining, otherwise, the rotation angle A as the final deflection angle.

3. The method for nail recognition and positioning according to claim 1, wherein the step S1 further comprises:
step S11: acquiring, by the recognition device, the first image information through photographing positions of fingers in the operating area, and sending the first image information to the target-detecting network to position nail sections in the first image information so as to generate the corresponding second image information mainly comprising image information of the nail sections;
step S12: sending the second image information to the segmentation network, pre-setting a probability value of judgment, obtaining a probability value that each pixel in an original hand image belongs to a nail section, marking pixel points with a probability value greater than the preset probability value as the nail section, marking pixel points with a probability value less than the preset probability value as a non-nail section, so as to obtain the nail mask images of the first image information.

4. The method for nail recognition and positioning according to claim 1, wherein the step S2 further comprises:
step S21: calculating the nail mask images and original 3D point cloud data to obtain true point cloud coordinates of the nails, wherein the original 3D point cloud data are data set in a real world; and
step S22: performing filtering on each nail mask image to eliminate noise points of the point cloud, such that an accuracy of image information is fed back through the point cloud.

5. The method for nail recognition and positioning according to claim 1, wherein the step S3 further comprises:
step S31: setting, based on the recognition device, an initial position of the printing device below the recognition device as the calibration coordinate system;
step S32: sending a true point cloud of the nails to the calibration coordinate system, wherein the true point cloud is obtained by combining the nail mask images with the original 3D point cloud.

6. The method for nail recognition and positioning according to claim 1, wherein the step S4 further comprises:
step S41: traversing, according to a point cloud of each nail, the nails, and obtaining basic data of the nails by combining point cloud data;
step S42: performing, after traversing the nails according to the point cloud data, data sorting for the point cloud of the nails to obtain the highest point, the left/right tilt angle, and the front/back tilt angle of the nail point cloud.

7. The method for nail recognition and positioning according to claim 1, wherein the step S5 further comprises:
step S51: projecting point cloud coordinates of the nails to the two-dimensional plane according to external parameters of the camera, performing Gaussian filtering to eliminate potential noise points, and obtaining the deflection angle of each nail according to the two-dimensional image.

8. The method for nail recognition and positioning according to claim 1, wherein the segmentation network comprises Unet, pspnet, deeplab series, for performing segmentation and comparison on the second image information.

9. The method for nail recognition and positioning according to claim 1, wherein the recognition device is one of a 3D camera, an RGB binocular camera, a 2D/3D laser radar, a 3D structured light camera, or a tof camera.

10. A system for nail recognition and positioning, applicable for the method according to claim 1, comprising:
an image processing module, configured to receive the first image information sent by the recognition device and generate the second image information according to nail sections corresponding to the first image information;
a communication module, configured to send the second image information to the segmentation network through the communication module to perform segmentation on an image of nail sections therein, and returning divided nail mask images to the image processing module;
a control module, configured to preset a probability value, to compare the divided second image information with the first image information, to determine a probability value that a corresponding pixel belongs to a nail section, to mark pixel points with a probability value greater than the preset probability value as the nail section, and to mark pixel points with a probability value less than the preset probability value as the non-nail section, so as to obtain the nail mask images of the first image information;
a 3D point cloud calculation module, configured to combine the nail mask images with the original 3D point cloud to obtain true point cloud coordinates of the nails, and convert the nail point cloud to the calibration coordinate system, so that the printing device performs printing according to a location of the calibration coordinate system; and
an information processing module, configured to collect and process calculated or converted 3D point cloud coordinates and to obtain the tilt angles according to the 3D point cloud coordinates.

11. The system for nail recognition and positioning according to claim 10, wherein the calibration coordinate system represents an x-y plane parallel to a plane of the printing device.
